(19) United States
(12) Patent Application Publication
(10) Pub. No.: US 2026/0139748 A1
(43) Pub. Date: May 21, 2026

(54) IMPROVED MULTIPORT ROTARY VALVE ASSEMBLY

(71) Applicant: ILiAD IP COMPANY, LLC, Carlsbad, CA (US)

(72) Inventors: John Lucas DRONE, Aurora, IL (US); Steven Michael HERNANDEZ, Belleville, WI (US)

(73) Assignee: ILiAD IP COMPANY, LLC, Carlsbad, CA (US)

(21) Appl. No.: 19/395,700

(22) Filed: Nov. 20, 2025

Related U.S. Application Data
(60) Provisional application No. 63/723,213, filed on Nov. 21, 2024.

(51) Int. Cl. F16K 11/085; F16K 37/00

(52) U.S. Cl. CPC F16K 11/0856; F16K 37/0083

(57) ABSTRACT

An improved multiport rotary valve assembly is disclosed for fluid control systems, particularly in direct lithium and mineral extraction applications. The assembly features a valve body comprising a housing ring, upper and lower closure discs, and a process disc, with advanced polymeric seals, including radial and lip seals, ensuring robust sealing engagement. A mechanically biased tensioning assembly, incorporating tension springs and load cells, maintains consistent sealing compression, mitigating issues of under-engagement and over-engagement caused by thermal and pressure variations. The valve assembly reduces leakage, cross-contamination, and seal degradation, enhancing extraction rates, operational efficiency, and seal longevity. Real-time monitoring and feedback mechanisms enable precise adjustments during startup, operation, and cooldown, minimizing manual intervention and downtime. This design addresses stringent purity requirements in direct lithium extraction while supporting high throughput and reliable performance under demanding conditions.

### CROSS-REFERENCE TO RELATED APPLICATIONS

This application claims the benefit of U.S. Provisional Patent Application No. 63/723,213 filed Nov. 21, 2024, and incorporates said provisional application by reference in its entirety into this document as if fully set out at this point.

### BACKGROUND OF THE INVENTION

### 1. Field of the Invention

The subject matter disclosed herein generally relates to fluid control systems, particularly a multiport rotary valve assembly having enhanced sealing engagement for applications in direct lithium and mineral extraction.

### 2. Description of the Related Art

The present disclosure relates generally to fluid control systems using multiport rotary valve assemblies for managing the flow of process liquids in applications such as direct lithium and mineral extraction. As the global demand for lithium continues to rise in support of battery technologies and clean energy initiatives, there is an increasing reliance on processes that can selectively separate and recover ions of interest from complex liquid feedstocks. In continuous countercurrent adsorption and desorption operations, multiport rotary valves serve as integral components for directing influent and effluent streams among multiple process zones. These valves are designed to accommodate varying process temperatures, pressures, and fluid chemistries while ensuring reliable sealing and minimal cross-contamination between adjacent flow paths.

In industrial extraction and separation contexts, the goal of valve systems is to provide precise and repeatable distribution of process fluids to or from ion-exchange or adsorption columns, resins, or membranes. Efficient valve operation supports higher throughput, reduced energy consumption, and consistent product purity. Given the stringent removal criteria in direct lithium extraction—often requiring impurity removal on the order of 99.9%—even minor leakage or flow crossover can compromise downstream purification steps and overall recovery rates. At the same time, these applications demand robust equipment capable of withstanding corrosive brines, elevated differential pressures, and cyclic thermal loads.

Existing multiport valve solutions often employ O-rings, radial seals, and bolted compression assemblies to maintain integrity between the rotating process disc and the stationary valve body. However, dimensional tolerances and seal compression requirements are sensitive to temperature differentials between ambient conditions and hot process streams. High sealing pressures intended to prevent crossflow can accelerate seal wear, distort mating surfaces, and increase torque requirements on drive motors. Manual tensioning of fasteners and bolts during maintenance or startup introduces variability and can require frequent adjustments to maintain consistent performance.

In direct lithium extraction operations, the adverse effects of crossflow and seal degradation are exacerbated by the requirement for ultra-high purity outputs. Thermal cycling during startup, operation, and cooldown can cause tensioning rods to tighten or loosen unpredictably, leading to under-engagement (fluid crossover) or over-engagement (seal damage). These fluctuations reduce operational efficiency, drive up maintenance frequency, and prolong downtime. There is an ongoing need for valve assemblies that can accommodate thermal and pressure variations while minimizing manual intervention and preserving seal life in demanding extraction environments.

### SUMMARY OF THE INVENTION

Therefore, it is desirable to provide an improved multiport rotary valve assembly and, more particularly, a multiport rotary valve assembly with enhanced sealing engagement and tightening assembly for maintaining sealing compression during direct lithium and mineral extraction applications. The valve assembly mitigates sensitivity to under-engagement (crossover) and over-engagement (seal compression and damage), alleviating the impact of temperature and pressure differentials on the valve assembly, and avoiding inconsistencies introduced by repeated manual intervention. The improved sealing engagement increases the extraction rates and extends the life of the sealing and wear surfaces within the multiport rotary valve assembly, while decreasing operating costs and maintenance downtime.

The arrangement of the valve body components, including the housing ring, upper and lower closure discs, and the rotatable process disc, ensures precise fluid distribution within the internal valve chamber. This configuration minimizes fluid leakage and cross-contamination between process zones, which is necessary for applications requiring ultra-high purity outputs, such as direct lithium extraction.

The use of an annular seal or sealing assembly constructed from low-friction polymeric materials between the housing ring and the process disc reduces wear and friction during operation. This material choice enhances the longevity of the seal while maintaining reliable sealing engagement under varying thermal and pressure conditions. The placement of the seal within the sidewall of the housing ring and the periphery of the process disc ensures robust sealing, even during rotational movement of the process disc.

The concentric seals or sealing assemblies, also constructed from low-friction polymeric materials, are strategically positioned between axially confronting sealing surfaces of the process disc and the upper and lower closure discs. This arrangement prevents fluid crossover between influent and effluent passageways, maintaining the integrity of process streams and supporting high-purity fluid separation.

The inclusion of a tensioning assembly with a biasing spring and tensioning rod applies a consistent axial compressive force to the closure discs, ensuring uniform sealing engagement across the valve body. This design compensates for thermal expansion and contraction during operation, reducing the risk of under-engagement or over-engagement that could lead to seal damage or fluid leakage.

The integration of load sensors and a controller provides real-time feedback on the tension force applied by the biasing spring. This enables dynamic adjustments to the preload on the spring, maintaining optimal sealing tension throughout startup, operation, and cooldown phases.

Overall, the combination of advanced sealing materials, precise component arrangement, and spring-biased tensioning mechanisms addresses the challenges of maintaining reliable sealing in demanding fluid control applications, enhancing extraction rates, reducing maintenance requirements, and ensuring consistent performance under fluctuating environmental conditions.

In general, in this first aspect, the invention relates to a multiport rotary valve assembly comprising a valve body with a housing ring defining an internal valve chamber, an upper closure disc and a lower closure disc secured to opposite ends of the housing ring, and a process disc rotatably received within the chamber. An annular low-friction polymeric seal is disposed between the housing ring sidewall and the process disc periphery, and a plurality of concentric low-friction polymeric seals are disposed between axially confronting surfaces of the process disc and the closure discs. A tensioning assembly applies axial compressive force to the closure discs and includes one or more tensioning rods extending through the valve body and a biasing spring engaged with each rod. At least one load sensor measures the tension force in the spring, and a controller monitors spring preload to maintain a predetermined sealing tension based on real-time feedback.

In an embodiment, the annular seal or sealing assembly comprises one or more radial seals constructed of one or more elastomeric or thermoplastic materials seated within a seal groove on the sidewall of the housing ring and/or the periphery of the process disc.

In an embodiment, the radial seals are constructed from the same material or different materials.

In an embodiment, the radial seals are constructed from fluorocarbon rubber (i.e., synthetic rubber and fluoropolymer elastomer), closed cell neoprene (e.g., standard 60A through 90A or higher durometer) (and any value or range therebetween), polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR) (e.g., carboxylated nitrile rubber (XNBR), hydrogenated nitrile rubber (HNBR)), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof.

In an embodiment, the concentric seals or sealing assemblies comprise lip seals constructed of one or more elastomeric or thermoplastic materials and seated within seal grooves on upper and lower sealing surfaces of the process disc, a lower sealing surface of the upper closure disc, and/or an upper sealing surface of the lower closure disc.

In an embodiment, one or more shims are respectively positioned beneath the lip seals.

In an embodiment, the lip seals are constructed from the same material or different materials.

In an embodiment, the lip seals are constructed from fluorocarbon rubber (i.e., synthetic rubber and fluoropolymer elastomer), closed cell neoprene (e.g., standard 60A through 90A or higher durometer) (any value or range therebetween), ethylene propylene diene monomer (EPDM) rubber, polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR) (e.g., carboxylated nitrile rubber (XNBR), hydrogenated nitrile rubber (HNBR)), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof.

In an embodiment, the lip seals are radial lip seals, axial lip seals, rotary lip seals, V-ring lip seals, or a combination thereof.

In an embodiment, the lip seals are torus-shaped seals, single-lip seals, double-lip seals, triple-lip seals, or a combination thereof.

In an embodiment, the lip seals are static seals, dynamic seals, spring-loaded seals, non-spring-loaded seals, or a combination thereof.

In an embodiment, the annular seal or sealing assembly, the concentric seals or seal assemblies, or both comprise a non-sealing element for stiffness selected from a metallic, thermoplastic, or thermosetting polymer element.

In an embodiment, the tension spring is a spring washer or a coil spring.

In an embodiment, the tension spring is a plurality of Belleville spring washers.

In an embodiment, the controller is configured to display tension and compression data on a display component mounted to the valve assembly.

In an embodiment, the controller is configured to monitor valve compression, which is used to selectively adjust the amount of sealing tension and compression applied to or maintained on the valve body in response to real-time feedback obtained from the load sensor during startup, operation, and/or cooldown of the valve assembly.

The invention further relates to a process for maintaining sealing compression of a multiport rotary valve assembly during thermal cycling. In this process, a mechanically biased tensioning assembly is mounted on the valve body, with a tensioning rod extending axially through the valve body and a tension spring engaged with both the rod and the valve body. The assembly is preloaded to a predetermined value at ambient temperature, establishing a baseline compression force that prevents both under-engagement and over-engagement of the seals before any thermal expansion occurs.

As the valve body is heated to a sealing temperature, the tensioning assembly adapts to changes in material dimensions caused by thermal expansion. Load sensors integrated with the tensioning assembly measure the sealing compression force exerted at the elevated temperature, providing real-time data on the actual tension applied. This measured force is then compared to a predetermined target sealing force, allowing for precise assessment of whether the assembly is operating within the optimal sealing range.

If the measured compression force deviates from the target, the position of at least one fastener along the tensioning rod is adjusted to bring the force back within the desired range. This adjustment compensates for the effects of thermal cycling, such as loosening or overtightening, and ensures that the sealing engagement remains reliable throughout startup, operation, and cooldown phases. By automating the monitoring steps, the process minimizes manual intervention, reduces maintenance downtime, and maintains consistent sealing performance.

This approach is particularly advantageous in applications requiring ultra-high purity outputs, such as direct lithium extraction, where even minor leakage or cross-contamination can compromise product quality. The process also extends the lifespan of seals and wear surfaces by preventing damage from improper tensioning, thereby contributing to higher throughput and reduced operational costs.

In general, in this second aspect, the invention relates to a process for maintaining sealing compression of a multiport rotary valve assembly during thermal cycling. The process mounts a mechanically biased tensioning assembly—comprising an axial tensioning rod and a tension spring—on the valve body, preloads the assembly to a predetermined preload at ambient temperature, and heats the valve body to a sealing temperature. A load sensor measures the sealing compression force at temperature, this measured force is compared to a target sealing force, and a fastener on the tensioning rod is repositioned as needed to keep the compression within the target range. The process can further include calculating the required spring rate or compression length, continuously monitoring tension and compression data, providing real-time feedback, and selectively adjusting sealing tension and compression during startup, operation, and cooldown. [0035]In an embodiment, the process also includes calculating a spring rate, compression length, or both that is necessary for the tension spring to create the predetermined target sealing force.

In an embodiment, the process also includes monitoring tension and compression data and providing real-time sealing tension and compression feedback from the tensioning assembly.

In an embodiment, the process also includes selectively adjusting an amount of sealing tension and compression applied to or maintained on the valve body in response to the real-time feedback obtained from the instrumentation of the tensioning assembly during startup, operation, and/or cooldown of the valve assembly.

### BRIEF DESCRIPTION OF DRAWINGS

The above and other objects and advantages of this invention may be more clearly seen when viewed in conjunction with the accompanying drawing wherein:

FIG. 1 is an elevation view of an example of a multiport rotary valve assembly constructed in accordance with an exemplary embodiment.

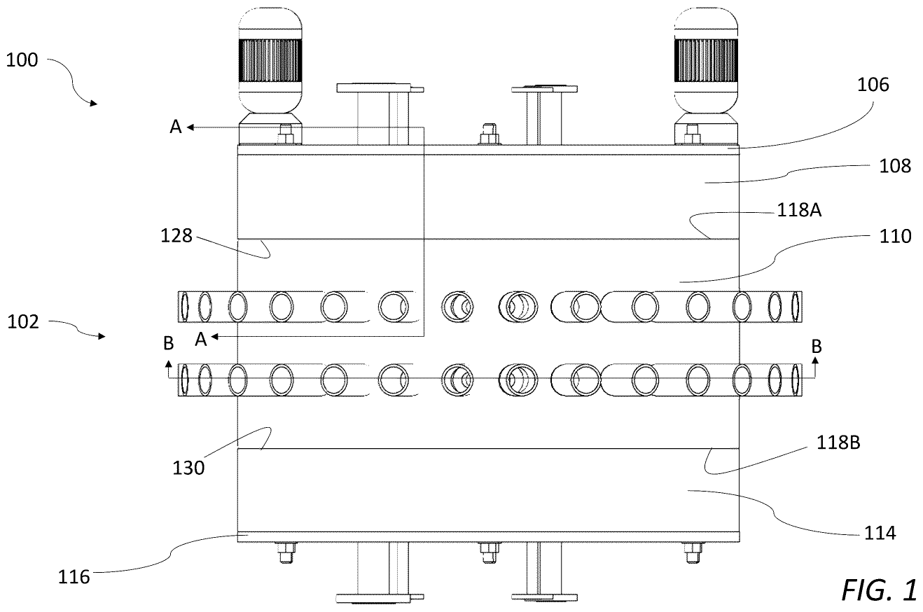

FIG. 2 is a perspective view of the valve assembly shown in FIG. 1.

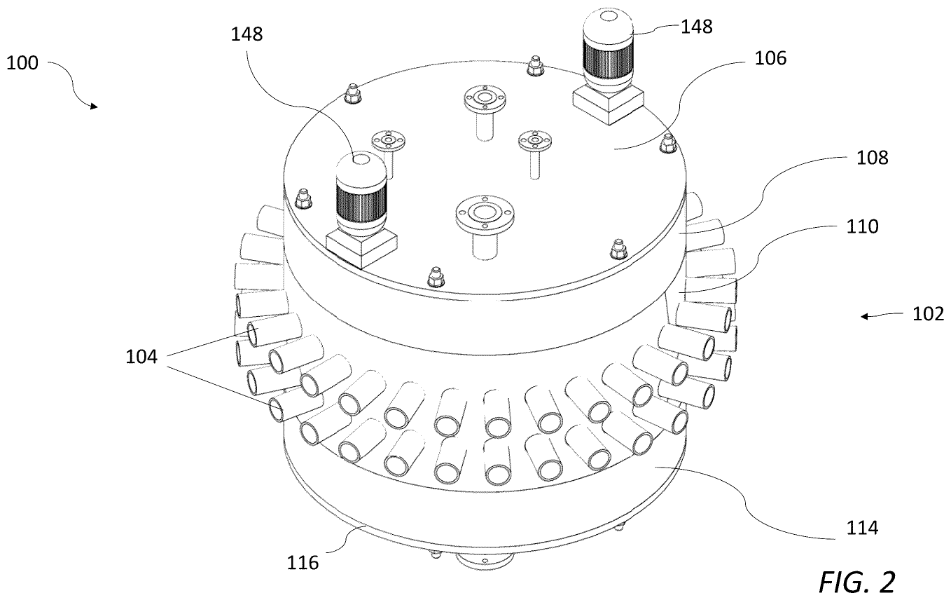

FIG. 3 is a cross-sectional view along lines A-A of FIG. 1.

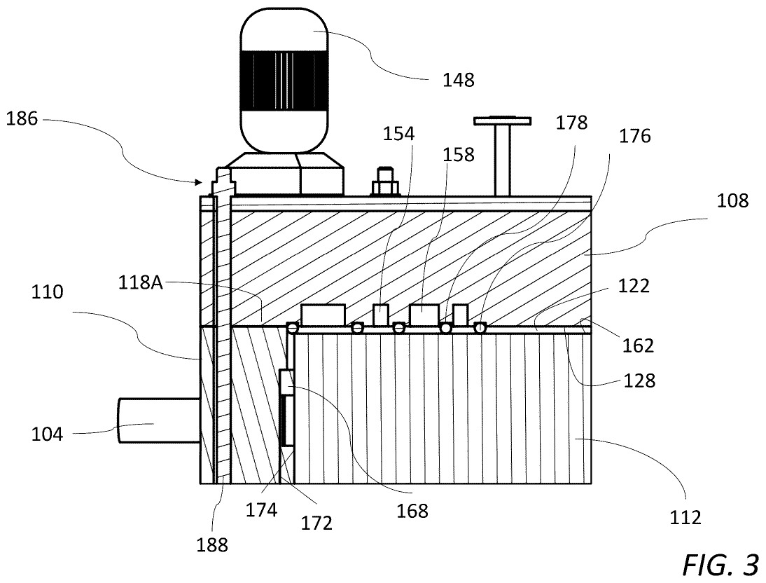

FIG. 4 is a cross-sectional view along lines B-B of FIG. 1.

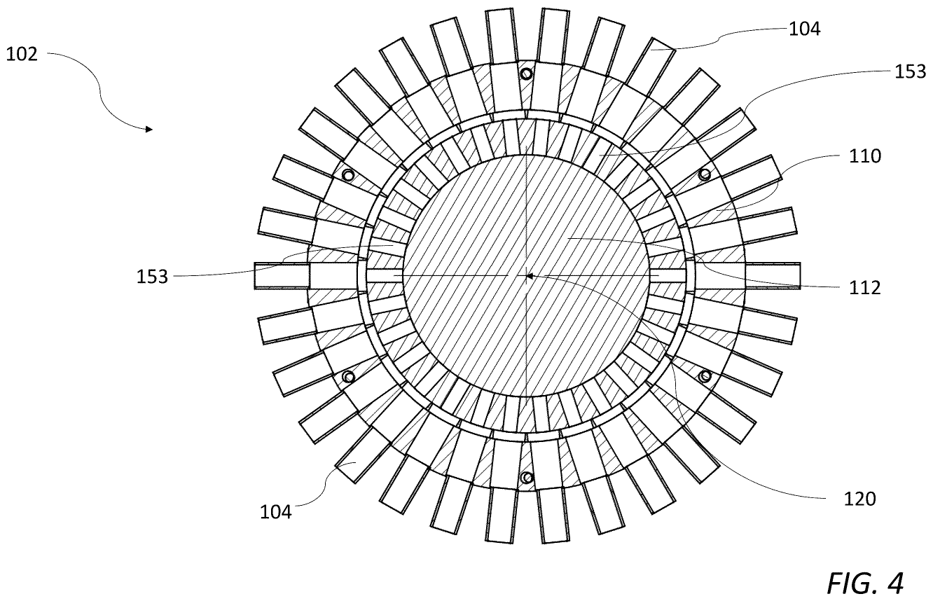

FIG. 5 is another cross-sectional view along lines A-A of FIG. 1.

FIG. 6 is a close-up view of area C shown in FIG. 5.

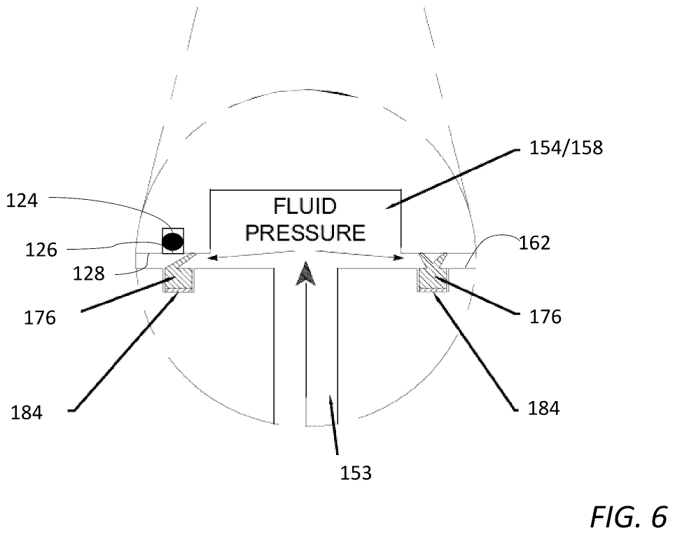

FIG. 7 is a partial cutaway side view of an example of a spring-biased compression or tensioning assembly constructed in accordance with an exemplary embodiment.

FIG. 8 is a partial cutaway side view of an example of a spring-biased compression or tensioning assembly constructed in accordance with another exemplary embodiment.

FIG. 9 is a flowchart of an example of a process for tensioning or sealing a multiport rotary valve assembly in accordance with an exemplary embodiment.

### DETAILED DESCRIPTION

The present detailed description provides illustrative embodiments of an improved multiport rotary valve assembly, particularly suited for fluid control systems in direct lithium and mineral extraction applications. The described assembly is presented in the context of continuous countercurrent adsorption and desorption processes, where precise fluid distribution and sealing engagement are necessary to achieve high-purity outputs and operational efficiency. While specific configurations, materials, and methods are disclosed herein, these examples are provided for illustrative purposes only and are not intended to limit the scope of the described assembly. [0049] Certain well-known principles, components, and techniques may not be described in detail to avoid obscuring the subject matter. Those skilled in the art will recognize that various modifications, substitutions, and rearrangements of the described embodiments can be made without departing from the spirit and scope of the disclosed technology. Accordingly, the disclosed technology encompasses all such variations and equivalents as defined by the appended claims. [0050] The global demand for lithium and other minerals necessary for advanced applications has driven the need for efficient extraction processes that can handle complex liquid feedstocks while achieving ultra-high purity outputs. Conventional fluid control systems, particularly multiport rotary valve assemblies, are integral to directing influent and effluent streams during continuous countercurrent adsorption and desorption operations. However, existing valve designs often suffer from significant limitations, including leakage, cross-contamination, and seal degradation under varying thermal and pressure conditions. These issues are intensified in direct lithium extraction (DLE) applications, where impurity removal requirements are stringent, and even minor seal failures can compromise downstream purification steps, reduce recovery rates, and increase operational costs. Additionally, conventional sealing mechanisms, such as O-rings, radial seals, and bolted compression assemblies, are prone to wear, distortion, and torque variability, necessitating frequent manual adjustments and maintenance, which further disrupt operational efficiency.

The present disclosure addresses these challenges by introducing an improved multiport rotary valve assembly with enhanced sealing engagement and a mechanically biased compression or tensioning assembly. The described valve assembly incorporates advanced polymeric seals, including radial and lip seals, constructed from low-friction, high-toughness materials to minimize leakage and extend seal longevity. These seals are strategically positioned within seal grooves on the valve body components, ensuring robust sealing engagement between the process disc, housing ring, and closure discs. Furthermore, the inclusion of a biasing tensioning assembly, featuring tension springs such as Belleville washers or coil springs, maintains consistent sealing compression across the valve body, even under fluctuating thermal and pressure conditions. Real-time monitoring and feedback mechanisms, enabled by load cells and sensors, allow for precise adjustments to sealing tension, reducing the need for manual intervention and ensuring optimal performance during startup, operation, and cooldown phases.

By mitigating under-engagement (fluid crossover) and over-engagement (seal compression damage), the valve assembly significantly improves extraction rates, reduces maintenance downtime, and enhances the overall reliability of fluid control systems in DLE and mineral recovery applications. The integration of advanced sealing materials, specialized seal geometries, and spring-biased tensioning mechanisms represents a substantial advancement over conventional approaches, addressing important industry needs for high-purity outputs and operational efficiency.

Referring to the figures of the drawings, wherein like numerals of reference designate like elements throughout the several views, a general arrangement for the improved multiport rotary valve assembly 100 is depicted. For purposes of illustration rather than limitation, the multiport rotary valve assembly 100 is exemplified in connection with process fluid distribution and transport during continuous countercurrent adsorption and desorption (“CCAD”) processes, such as selective lithium and mineral recovery from natural and synthetic feedstocks. However, the multiport rotary valve assembly 100 should not be so limited, as the invention can be utilized in other fluid flow applications. The improved multiport rotary valve assembly 100 mitigates under-engagement (fluid flow crossover) and/or over-engagement (seal compression and damage) and, as a result, increases the overall extraction rates, extends the life of both sealing and wear surfaces within the valve assembly, decreases operating costs, and decreases both production and maintenance downtimes.

As exemplified in the figures, the valve assembly 100 includes a valve body 102 fluidly connected via distribution ports 104 to a plurality of external vessels (e.g., ion exchange or adsorption and desorption columns or beds) (not shown) for process fluid distribution and transport. The adsorbent beds or columns are arranged into process zones, each containing an adsorbent or resin (e.g., a lithium-or mineral-selective adsorbent or ion-exchange resin). Distribution of process fluids through the multiport rotary valve assembly 100 is conducted via internal porting of distribution channels 153 within the valve body 102 before flowing to the columns or vessels from the distribution ports 104 in predetermined process sequences.

The valve body 102 of the multiport rotary valve assembly 100 includes an upper deflection plate 106, an upper closure disc 108, a body or housing ring 110, a process disc 112, a lower closure disc 114, and a lower deflection plate 116. The housing ring 110 has opposing generally planar axial or open ends 118A/118B and is configured to surround the perimeter of the process disc 112. The housing ring 110, along with the upper and lower closure discs 108 and 114, defines an internal valve chamber 122. The process disc 112 is seated within the internal valve chamber 122 and is rotatable about a central axis 120. The process disc 112 may be made of polymeric materials that are subject to temperature distortion exacerbated by the differential between ambient external temperatures and internal process temperatures. The process disc 112 can be a unitary construction or be constructed from multiple process discs and materials stacked coaxially, sealed, and connected within the housing ring 110. The upper closure disc 108, the process disc 112, and the lower closure disc 114 are coaxially aligned and axially spaced along the central axis 120.

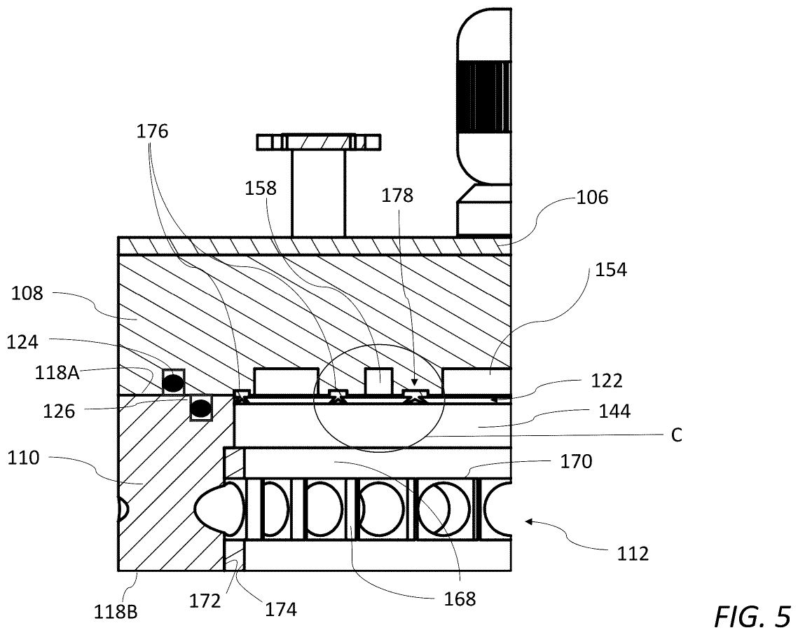

The housing ring 110 defines end openings 118A/118B with the upper closure disc 108 and the lower closure disc 114 secured thereto, respectively. The upper closure disc 108 and the lower closure disc 114 can be sealed with respect to the housing ring 110 by annular seals or seal assemblies 124. The seal assemblies 124 can be carried within circular seal grooves 126 defined in the end openings 118A/118B of the housing ring 110, in the periphery of a lower sealing surface 128 of the upper closure disc 108, and/or in the periphery of an upper sealing surface 130 of the lower closure disc 114 (not shown/mirror image of the foregoing shown in FIG. 5). The annular seals or seal assemblies 124 may be elastomer or polymer seals that provide sealing within a normal operating temperature range.

The upper deflection plate 106, the upper closure disc 108, the lower closure disc 114, the lower deflection plate 116, and/or the housing ring 110 can be flanged, threaded, or otherwise configured to match that of the mating connection; for example, a plurality of axially aligned fastener openings can be provided to receive bolts, threaded studs, tensioning rods, or the like to secure the upper deflection plate 106, the upper closure disc 108, the lower closure disc 114, and the lower deflection plate 116 in sealing engagement to the respective end openings 118A/118B of the housing ring 110, and thereby compressing the process disc 112 within the housing ring 110. The upper deflection plate 106 and the lower deflection plate 116 distribute the compressive load from the tensioning rods to the upper and lower closure discs 108/114 and the housing ring 110, thereby sealing the valve body 102 and constraining the process disc 112. Additionally, the process disc 112 and the internal valve chamber 122 of the housing ring 110 can be conically shaped (e.g., cone frustum shaped; however, other geometries may be used) such that the vertical compressive forces are translated into semi-horizontal compressive forces that engage the housing ring 110.

As noted above, the process disc 112 is seated within the internal valve chamber 122 of the housing ring 110 and rotates at a predetermined rate about the central axis 120 to direct the process fluid flow to and from the columns or vessels in predetermined process sequences. The process disc 112 rotation is driven by one of several possible external motors, gearboxes, and internal gearing arrangements. By way of example, an external ring gear 144 is affixed to the process disc 112 and engages with an internal gear driven by a gearmotor 148. The exact number of gearmotors 148 is determined by the size of the valve assembly 100 and the process conditions and requirements. As illustrated, each gearmotor 148 can be affixed to the upper deflection plate 106, and each gearmotor 148 is configured to transmit rotation to the process disc ring gear 144 using the gear affixed to an output shaft of the gearmotor 148, which passes through the upper deflection plate 106 and the upper closure disc 108. A motor controller (not shown) is configured to control the rotational rate and torque by varying the frequency and voltage of the electric power to the gearmotor 148. The rotational movement may be continuous or stepped. The motor controller can be a variable-frequency drive (VFD) (e.g., a Voltage-Source Inverter (VSI), a Current-Source Inverter (CSI), or a Pulse Width Modulation Inverter (PWM)), adjustable-frequency drive, adjustable-speed drive, variable-speed drive, AC drive, micro drive, inverter drive, or other suitable type of motor controller.

A feedstock stream is fluidly sent to influent passageways 154 in the upper closure disc 108 and influent passageways (not shown/mirror image of the influent passageways 154 in the upper closure disc 108) in the lower closure disc 114, respectively extending through the upper closure disc 108 and the lower closure disc 114. A product stream is fluidly sent to effluent passageways 158 in the upper closure disc 108 and effluent passageways (not shown/mirror image of the effluent passageways 158 in the upper closure disc 108) in the lower closure disc 114, which respectively extend through the upper closure disc 108 and the lower closure disc 114. The influent passageways 154 and the effluent passageways 158 in the upper closure disc 108 and the influent passageways and the effluent passageways in the lower closure disc 114 are fluidly connected to one or more distribution channels 153 on or in the process disc 112. The distribution channels 153 are open to an upper sealing surface 162 and a lower sealing surface (not shown/mirror image of the upper sealing surface 162) of the process disc 112 such that each distribution channel 153 corresponds to one of the influent passageways 154 in the upper closure disc 108 and/or one of the influent passageways in the lower closure disc 114 and one of the effluent passageways 158 in the upper closure disc 108 and/or one of the effluent passageways in the lower closure disc 114, which correspond to a particular process zone and is sealed against the other zones using concentric internal seals or seal assemblies 176 in the upper sealing surface 162 or the lower sealing surface (not shown/mirror image of the upper sealing surface 162). The distribution channels 153, the influent passageways 154 in the upper closure disc 108, the influent passageways in the lower closure disc 114, the effluent passageways 158 in the upper closure disc 108, and the effluent passageways in the lower closure disc 114 are respectively aligned during the rotation of the process disc 112 due to the concentric orientation of the influent passageways 154 in the upper closure disc 108 and the influent passageways in the lower closure disc 114 and the effluent passageways 158 in the upper closure disc 108 and the effluent passageways in the lower closure disc 114 and the distribution channels 153.

Internal porting of the distribution channels 153 within the process disc 112 distributes the process fluid from distribution ports 104 in the housing ring 110 to and from the columns or vessels arranged into process zones in predetermined process sequences. Upon return from the columns or vessels, the process fluid is either further distributed through additional process zones or fluidly sent from the effluent passageways 158 in the upper closure disc 108 and effluent passageways in the lower closure disc 114 to an external tank or vessel (not shown). Based on the material construction of the process disc 112, the multiport rotary valve assembly 100 is subject to fluid leakage if the spaces between the housing ring 110 and/or the upper and lower closure discs 106/114 and the process disc 112 are not properly sealed, especially during DLE applications. Further, the distribution channels 153, influent passageways 154 in the upper closure disc 108 and influent passageways in the lower closure disc 114, and effluent passageways 158 in the upper closure disc 108 and effluent passageways in the lower closure disc 114 may carry several different process fluids, and the proximity of the various process fluids within the valve body 102 and process disc 112 presents potential leak paths, thus requiring sealing engagement.

Accordingly, the process disc 112 and the housing ring 110 are sealed by one or more annular seals or sealing assemblies 168 to minimize process fluid leakage between the process disc 112 and the distribution ports 104 in the housing ring 110. The seal assembly(s) 168 can be carried within seal grooves 170 on a sidewall sealing surface 172 of the housing ring 110 and/or a sidewall sealing surface 174 of the process disc 112.

In addition to sealing engagement with the housing ring 110, the process disc 112 is sealed with respect to the upper closure disc 108 and the lower closure disc 114 by the internal seals or seal assemblies 176. The seal assemblies 176 can be carried within concentric seal grooves 178 on the upper sealing surface 162 and the lower sealing surface of the process disc 112 and/or the lower sealing surface 128 of the upper closure disc 108 and the upper sealing surface 130 of the lower closure disc 114. The seal assemblies 176 minimize process fluid leakage between influent passageways 154 in the upper closure disc 108 and influent passageways in the lower closure disc 114 and effluent passageways 158 in the upper closure disc 108 and effluent passageways in the lower closure disc 114 in the interface between the upper and lower closure discs 108 and 114 and the process disc 112.

In order to achieve better sealing and to mitigate long-term damage during operating conditions, the annular seals 168 and/or the concentric internal seals 176 may be polymeric (elastomeric or thermoplastic) seals that provide sealing within a normal operating temperature range, in particular for DLE applications. The seals or seal assemblies 168/176 may be wholly polymeric or supported by a non-sealing element for stiffness (metallic, thermoplastic, or thermosetting polymer). The annular seals 168 and/or the concentric internal seals 176 can be made from the same or different materials that will reduce friction and increase toughness. As exemplified, the annular seals or sealing assemblies 168 between the housing ring 110 and the process disc 112 can be radial seals, and the concentric internal seals or seal assemblies 176 between the process disc 112 and the upper closure disc 108 and the lower closure disc 114 can be lip seals (e.g., radial lip seals, axial lip seals, rotary lip seals, V-ring lip seals). The internal seals 176 may have various profiles, including but not limited to torus-shaped seals, single-lip seals, double-lip seals, or triple-lip seals. The orientation of the lip seal “lip” will be such that fluid pressure imparts additional sealing potential instead of reversing it. It will be appreciated that various lip seal profiles will result in various lip seal lip orientations to achieve this additional sealing potential. In addition, the internal seals 176 can be static seals, dynamic seals (e.g., bidirectional dynamic seals), spring-loaded, or non-spring-loaded seals.

As noted above, the annular seals 168 and the internal seals 176 can be any suitable polymeric (elastomeric or thermoplastic) material with or without a non-sealing element for stiffness. For example, the annular seals 168 can be constructed from fluorocarbon rubber (i.e., synthetic rubber and fluoropolymer elastomer), closed cell neoprene (e.g., standard 60A through 90A or higher durometer) (and any value or range therebetween), ethylene propylene diene monomer (EPDM) rubber, polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR) (e.g., carboxylated nitrile rubber (XNBR), hydrogenated nitrile rubber (HNBR)), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof. Additionally, the internal seals 176 can be constructed from fluorocarbon rubber (i.e., synthetic rubber and fluoropolymer elastomer), closed cell neoprene (e.g., standard 60A through 90A or higher durometer) (and any value or range therebetween), ethylene propylene diene monomer (EPDM) rubber, polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR) (e.g., carboxylated nitrile rubber (XNBR), hydrogenated nitrile rubber (HNBR)), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof. It will be appreciated that other low-friction and/or high-toughness materials may be suitable in various applications to provide reliable sealing, increased seal longevity, or both. Using low-friction and/or high-toughness materials helps to mitigate long-term deformation of the annular seals 168 and/or the internal seals 176 due to compression and rubbing friction.

Accordingly, and as exemplified in the figures, the annular seals 168 of the multiport rotary valve assembly 100 can be one or more radial seals 168 seated within the seal grooves 170 on the sealing surface 172 of the housing ring 110 and/or the sealing surface 174 of the process disc 112. The internal seals 176 of the valve assembly 100 can be one or more lip seals 176 seated within the seal grooves 178 on the upper and/or lower sealing surfaces 162 of the process disc 112 and/or the sealing surfaces 128/130 of the upper closure disc 108 and the lower closure disc 114. The radial seals 168 and/or the lip seals 176 are respectively retained within the seal grooves 170/178 using compressive forces. In addition, the pressure of the process fluid, acting on the area differential between the influent passageways 154 in the upper closure disc 108 and influent passageways in the lower closure disc 114, and the effluent passageways 158 in the upper closure disc 108 and effluent passageways in the lower closure disc 114, will develop a resultant force acting in a direction toward the lip seals 176. Thus, the greater the pressure of the process fluid flowing through the valve assembly 100, the greater the sealing capability of the lip seals 176. Because fluid pressure assists in sealing the lip seals 176, the detrimental effects of high compression forces within the multiport rotary valve assembly 100, such as damage to the radial seals 168, are mitigated.

Depending on the dimensions of the housing ring 110 and upper and lower closure discs 108/114 and the depth of the radial seal grooves 170 and/or lip seal grooves 178, proper engagement of both the radial seals 168 and the lip seals 176 may be difficult due to the internal geometry of the valve chamber 122 of the housing ring 110 and/or the process disc 112. One or more of the lip seal grooves 178 can optionally include at least one shim 184 to alleviate gap issues. For example, the shim(s) 184 may be used to ensure proper sealing height for the lip seals 176 between the upper and lower closure discs 103/104 and the process disc 112. Shims 184 may also be required to ensure proper sealing, based on the available seal profile dimensions and corresponding seal groove depths.

Sealing engagement between the sealing surfaces (upper sealing surface 162, lower sealing surface, and sidewall sealing surface 174) of the process disc 112 and corresponding sealing surfaces 128/130 of the upper and lower closure discs 108/114 and sealing surface 172 of the housing ring 110 is achieved by compressing the valve body 102 of the valve assembly 100 using one or more compression or tensioning assemblies 186 axially biased by a tension spring 192 and engaged with the outside perimeter of the valve body 102. When engaged, the axially biasing tensioning assembly(s) 186 forces the upper deflection plate 106, the upper closure disc 108, the lower closure disc 114, and the lower deflection plate 116 in sealing engagement to the respective end openings 118A/118B of the housing ring 110, thereby compressing the internal seals 176 along the upper sealing surface 162 and the lower sealing surface of the process disc 112 and/or the lower and upper sealing surfaces 128/130 of the upper closure disc 108 and the lower closure disc 114. Additionally, the sidewall sealing surface 172 of the housing ring 110 and the sidewall sealing surface 174 of the process disc 112 will mate under compressive forces exerted by the tensioning assembly 186.

The tensioning assembly 186 maintains the valve assembly 100 under consistent sealing compression during startup, operation, and cooldown, allowing for more precise tensioning during valve tightening. These benefits enable the valve assembly 100 and the internal seals 168/176 to operate with greater consistency and longer longevity under constant compression, facilitated by the axial biasing provided by the tensioning spring 192. The valve tensioning assembly 186 includes a compression or tensioning rod 188 disposed through axially aligned fastener openings 196A/196B in the valve assembly 100. An upper end 188A and a lower end 188B of the tensioning rod 188 are respectively connected to a fastener 190A/190B to secure the upper deflection plate 106, the upper closure disc 108, the lower closure disc 114, and the lower deflection plate 116 in sealing engagement to the respective end openings 118A/118B of the housing ring 110, and thereby compressing the process disc 112 within the housing ring 110 of the valve body 102.

The spring-biased tensioning assembly 186 also includes the tension spring 192 (and washers 198A/198B) positioned between the fastener 190A/190B and the upper deflection plate 106 and/or the lower deflection plate 116. The tension spring 192 adds tension to the tensioning rod 188 and maintains a consistent minimum tension to the valve body 102 compression. More particularly, the tension spring 192 allows a minimum amount of tension to be maintained on the valve body 102 during fluctuations in ambient and environmental temperatures, as well as operating fluid temperatures.

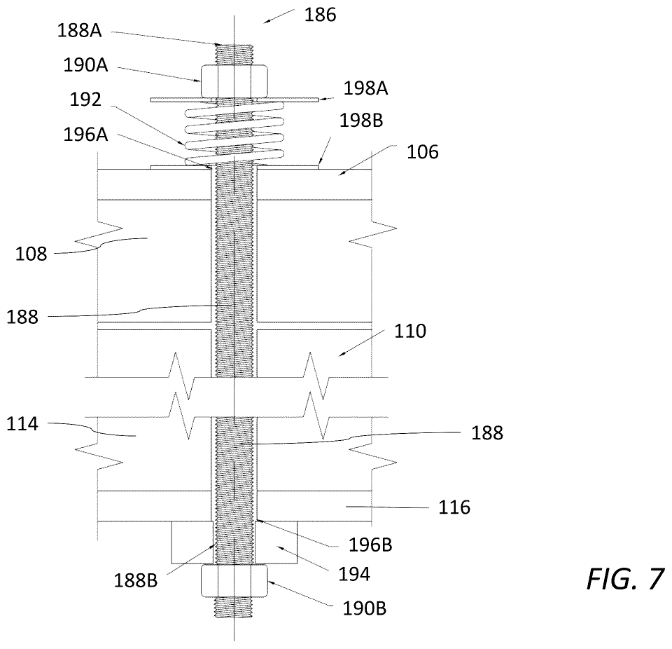

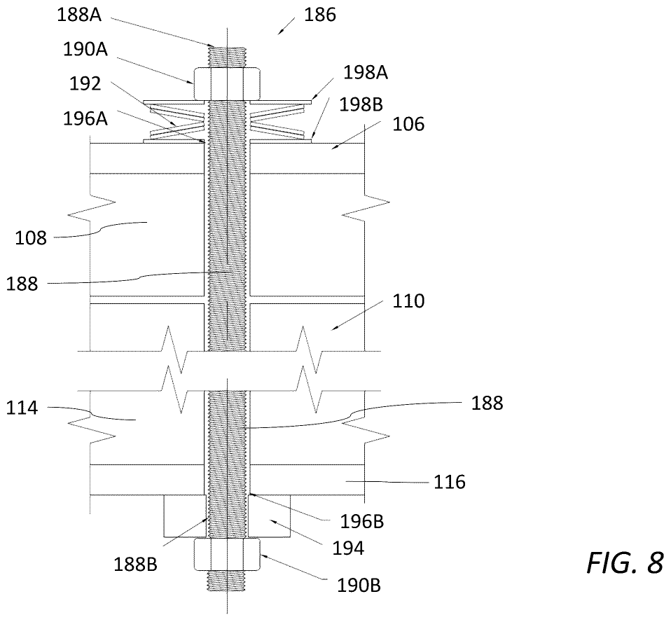

Suitable tension springs 192 can include any suitable compression spring that provides a constant or variable resistance during compression of the valve body 102. By way of example and not limitation, the tension spring 192 can be a compression or coil spring (e.g., a constant, variable, or variable stiffness spring) (e.g., FIG. 7) or a spring washer (e.g., a Belleville spring washer) (e.g., FIG. 8). In an embodiment, the tension spring 192 is one or more stacked spring washers, and the number of spring washers can be even (e.g., 2, 4, 6, or 8, etc. washers); however, it will be appreciated that an even or odd number of spring washers is suitable for some applications to achieve a desired compression height. The spring washers 192 may be stacked such that either the narrow ends of adjacent spring washers are in contact (e.g., FIG. 8), the wide ends are in contact, or other configurations as needed to secure the required pre-tension.

The tensioning assembly 186 can also include a load cell (e.g., strain gauge load cell, capacitive load cell, pneumatic load cell, hydraulic load cell, piezoelectric load cell), load washer, or other similar instrumentation 194 to measure the tension of the tensioning assembly 186 and thus correlated to a compression force of the valve assembly 100. The tensioning assembly 186 could also include a computer processor that provides real-time feedback and data on the amount of tension on the valve body 102. The tensioning assembly 186 can include a controller that monitors valve compression, which is used to selectively adjust the amount of tension and compression applied to or maintained on the valve body 102 in response to real-time feedback data obtained from the instrumentation of the tensioning assembly 186 during startup, operation, and cooldown.

The real-time data, including compression and tensioning data, can be stored using the computer processor/controller and displayed on an LCD display mounted to the valve assembly 100. In addition, the tensioning assembly 186 can include a power switch and a plurality of indicator lights to visually display power status, system alarm status, tensioning pressure, logging, compression metrics, and other operational statuses.

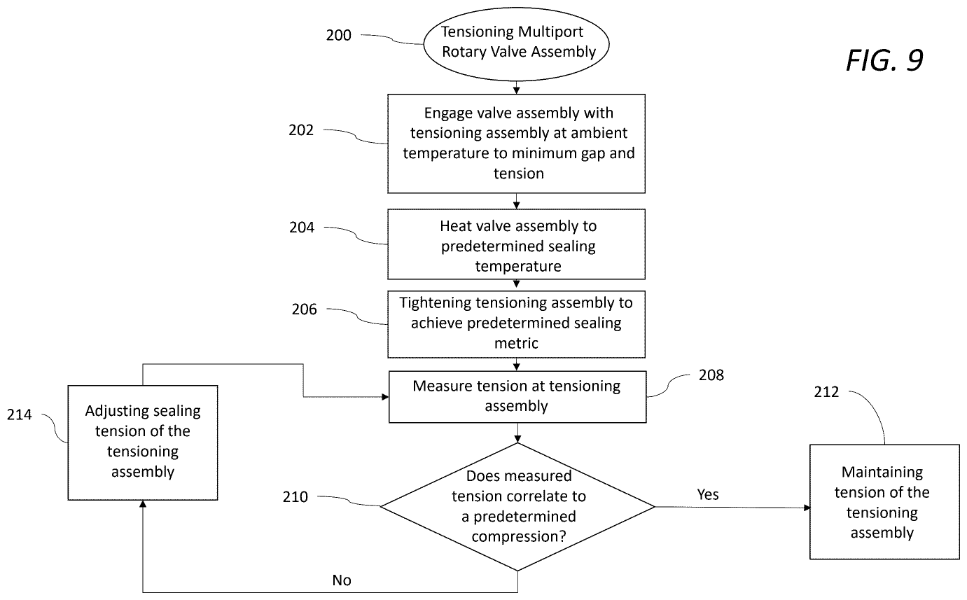

Turning to FIG. 9, a process 200 for tensioning and sealing the valve assembly 100 with consistent minimum tension involves step 202 of engaging the valve assembly 100 with the tensioning assembly 186 at ambient temperature, followed by step 204 of heating the valve assembly 100 to a predetermined sealing temperature and step 206 of tightening the tensioning assembly 186 to achieve a sealing metric. Step 202 may involve engaging the tensioning rod 188 with the valve body 102 under a set preload. As used here, the term “preload” is understood to refer to a load applied to the tensioning rod 188 by virtue of engagement with the valve body 102 before the application of any external loads imparted by the valve body 102 due to thermal expansion from ambient temperature or operating temperature changes. Step 206 may involve moving the fastener 190 respectively closer to or further from the deflection plates 106/116 along the tensioning rod 188, and the sealing metric may be a desired compression height for the tension spring 192, a predetermined minimum tension, a corresponding predetermined minimum compression, a corresponding predetermined minimum torque (verified via torque meter, wrench, or other instrumentation), or an initial gap between the components of the valve assembly 100. After heating, thermal variations (cooling) may result in loosening of the tensioning rod 188; however, loosening will not occur beyond the given preload at ambient temperature.

The process 200 may also include step 208, which involves measuring tension at the tensioning rod 188. This step 208 may be performed using at least one ring gauge. In one embodiment, the measured tension is compared with the predetermined minimum tension desired for the biasing tensioning assembly 186 at step 210. If the measured tension matches the predetermined minimum tension, the position of the fasteners 190 is maintained along the tensioning rods 188 (step 212). If the measured tension does not match the predetermined minimum tension, the process 200 may include step 214 of adjusting the position of the fasteners 190 along the tensioning rods 188 to establish the predetermined minimum tension. Once the fasteners 190 are repositioned along the tensioning rods 188, the process 200 may be returned to steps 208 and 210 to measure and compare tension at the tensioning rods 188 to the predetermined minimum tension. It will be appreciated that steps 208 through 214 could be performed during the initial set-up of the valve tensioning assembly 186 to confirm that the predetermined minimum tension has been established or periodically after the valve body 102 has been in operation to confirm that the tension has not changed, such that the biasing tensioning assembly 186 still provides the predetermined minimum compression of the valve assembly 100.

The process 200 may also include a step of calculating spring rates (e.g., minimum and maximum spring rates) and/or compression length necessary for the tension spring 192 to create the predetermined minimum tension. This step may be performed before the valve tensioning assembly 186 is engaged with the valve assembly 100.

The valve assembly 100, including the tensioning assembly 186, can include a processing component, a memory component, a display component, a control component, a communication component, a power component, and an optional mode sensing component.

The processing component includes a microprocessor, a single-core processor, a multi-core processor, a microcontroller, a logic device (e.g., programmable logic device configured to perform processing functions), a digital signal processing (DSP) device, or some other type of generally known processor, including image processors and/or video processors. The processing component is designed to interface with and communicate with the components of the tensioning assembly 186, enabling it to perform the method and processing steps described herein. The processing component may include one or more modules for operating in one or more modes of operation. These modules can be adapted to define preset processing and/or display functions that can be embedded in the processing component or stored on the memory component for access and execution by the processing component. For example, a processing component may be adapted to operate, control, and monitor tensioning and compression data of the valve body 102 in a memory component. In other various embodiments, the processing component may be adapted to perform various types of valve tensioning processing algorithms and/or various modes of operation, as described herein.

It should be appreciated that each module may be integrated in software and/or hardware as part of a processing component, or code (e.g., software or configuration data) for each mode of operation associated with each module, which may be stored in a memory component. Modules may be stored by a separate computer-readable medium (e.g., a memory, such as a hard drive, a compact disk, a digital video disk, or a flash memory) to be executed by a computer (e.g., logic or processor-based system) to perform various methods disclosed herein.

In one example, the computer-readable medium may be portable and/or located separately from the valve assembly 100, with stored modules provided to the valve assembly 100 by coupling the computer-readable medium to the tensioning assembly 186 and/or by the tensioning assembly downloading (e.g., via a wired or wireless link) the modules from the computer-readable medium (e.g., containing the non-transitory information). In various embodiments, as described herein, modules provide for improved tensioning and compression monitoring processing techniques for real-time applications.

The memory component includes one or more memory devices to store data and information, including tensioning and compression data. The one or more memory devices may include various types of memory for data storage, including volatile and non-volatile memory devices, such as RAM (Random Access Memory), ROM (Read-Only Memory), EEPROM (Electrically-Erasable Read-Only Memory), flash memory, etc. In one embodiment, the processing component is adapted to execute software stored on the memory component to perform various methods, processes, and modes of operations in a manner as described herein.

A regulation component includes one or more load or pressure sensors for capturing data related to the tensioning and compression of the valve body. The load or tension-based sensors may be adapted to determine the amount of tension between the housing ring 110, the upper closure disc 108, and the lower closure disc 118 using compression data. Tension sensors record tension and compression data on the valve body during startup, operation, and cooldown. The processing component may be adapted to tension and compression data from the regulation component, process load signals, store tension and load signals or data in the memory component, and/or retrieve stored tension and compression data from the memory component. The processing component may be adapted to process tension and load signals or data stored in the memory component, providing tension and compression data to the display component for viewing by the user.

A display component, in one embodiment, includes an image display device (e.g., a liquid crystal display (LCD)) or various other types of generally known video displays or monitors. The processing component may be adapted to display tension and compression data and information on the display component. The processing component may be adapted to retrieve tension and compression data and information from the memory component and display any retrieved tension and compression data and information on the display component. The display component may include display electronics that are utilized by the processing component to display tension and compression data and information. The display component may receive tension data and information directly from the regulation component via the processing component, or the tension and compression data and information may be transferred from the memory component via the processing component.

A control component includes a user input and/or interface device having one or more user-actuated components. For example, actuated components may include one or more push buttons, slide bars, rotatable knobs, and/or a keyboard that are adapted to generate one or more user-actuated input control signals. The control component may be adapted to be integrated as part of the display component, functioning as both a user input device and a display device, such as, for example, a touch screen device that receives input signals from a user touching different parts of the display screen. The processing component may be adapted to sense control input signals from the control component and respond to any sensed control input signals received therefrom. [0086] The control component may include a control panel unit (e.g., a wired or wireless handheld control unit) having one or more user-activated mechanisms (e.g., buttons, knobs, sliders) adapted to interface with a user and receive user input control signals. In various embodiments, one or more user-activated mechanisms of the control panel unit may be utilized to select between the various modes of operation, as described herein in reference to the stored modules. In other embodiments, it should be appreciated that the control panel unit may be adapted to include one or more other user-activated mechanisms to provide various other control functions of the valve assembly and/or the tensioning assembly.

In another embodiment, control component may include a graphical user interface (GUI), which may be integrated as part of display component (e.g., a user actuated touch screen), having one or more images of the user-activated mechanisms (e.g., buttons, knobs, sliders, etc.), which are adapted to interface with a user and receive user input control signals via the display component.

A communication component may include, in one embodiment, a network interface component (NIC) adapted for wired and/or wireless communication with a network that includes other devices. In various embodiments, communication component may include a wireless communication component, such as a wireless local area network (WLAN) component based on the IEEE 802.11 standards, a wireless broadband component, mobile cellular component, a wireless satellite component, or various other types of wireless communication components including radio frequency (RF), microwave frequency (MWF), and/or infrared frequency (IRF) components, such as wireless transceivers, adapted for communication with a wired and/or wireless network. As such, the communication component may include an antenna coupled thereto for wireless communication purposes. In other embodiments, the communication component may be adapted to interface with a wired network via a wired communication component, such as a DSL (e.g., Digital Subscriber Line) modem, a PSTN (Public Switched Telephone Network) modem, an Ethernet device, and/or various other types of wired and/or wireless network communication devices adapted for communication with a wired and/or wireless network. The communication component may be adapted to transmit and/or receive one or more wired and/or wireless video feeds.

In various embodiments, the network may be implemented as a single network or a combination of multiple networks. For example, in various embodiments, the network may include the Internet and/or one or more intranets, landline networks, wireless networks, and/or other appropriate types of communication networks. In another example, the network may include a wireless telecommunications network (e.g., cellular phone network) adapted to communicate with other communication networks, such as the Internet. As such, in various embodiments, the valve assembly and/or the tensioning assembly may be associated with a particular network link, such as, for example, a URL (Uniform Resource Locator), an IP (Internet Protocol) address, and/or a mobile phone number.

A power component comprises a power supply or power source adapted to provide power to the tensioning assembly, including each of the components. The power component may comprise various types of power storage devices, such as a battery, or a power interface component adapted to receive external power and convert it to usable power for the valve assembly and the tensioning assembly, including each of these components.

A mode sensing component may be optional. The mode sensing component may include, in one embodiment, an application sensor adapted to automatically sense the mode of operation, depending on the sensed application (e.g., the intended use for an embodiment), and provide related information to the processing component. In various embodiments, the application sensor may include a mechanical triggering mechanism (e.g., a clamp, clip, hook, switch, push-button, etc.), an electronic triggering mechanism (e.g., an electronic switch, push-button, electrical signal, electrical connection, etc.), an electro-mechanical triggering mechanism, an electro-magnetic triggering mechanism, or some combination thereof. Alternatively, for one or more embodiments, the mode of operation may be controlled by a user of the tensioning assembly via a control component.

A processing component may be adapted to communicate with a mode sensing component (e.g., by receiving sensor information from the mode sensing component) and the regulation component (e.g., by receiving data and information from the regulation component and providing and/or receiving command, control, and/or other information to and/or from other components of the tensioning assembly).

As used herein, the term “computer” may refer, but is not limited to, a laptop or desktop computer, or a mobile device, such as a desktop, laptop, tablet, cellular phone, smart phone, personal media user (e.g., iPod), wearable computer, implantable computer, or the like. Such computing devices may operate using one or more operating systems, including, but not limited to, Windows, MacOS, Linux, UNIX, iOS, Android, Chrome OS, Windows Mobile, Windows CE, Windows Phone OS, Blackberry OS, and the like.

The system and process described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, and instructions described herein and elsewhere may be executed by one or more of the network infrastructural elements.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method be operated in a particular orientation. Terms such as “connected,” “connecting,” “attached,” “attaching,” “join,” and “joining” are used interchangeably and refer to one structure or surface being secured to another structure or surface or integrally fabricated in one piece.

For purposes of the disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, the range of 25 to 100 should be interpreted to mean a range with a lower limit of 25 and an upper limit of 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only, and decimal and fractional values (e.g., 46.7-91.3) should also be understood to be intended as possible subrange endpoints unless specifically excluded.

Although an overview of the disclosed subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A multiport rotary valve assembly, comprising:
a valve body comprising a housing ring defining an internal valve chamber, an upper closure disc and a lower closure disc secured to opposing axial ends of the housing ring, and a process disc rotatably received within the internal valve chamber;
an annular seal or sealing assembly constructed of a low-friction polymeric material and disposed between a sidewall of the housing ring and a periphery of the process disc;
a plurality of concentric seals or sealing assemblies constructed of a low-friction polymeric material and disposed between axially confronting sealing surfaces of the process disc and the upper and lower closure discs;
a tensioning assembly configured to apply an axial compressive force to the closure discs, the tensioning assembly comprising:
at least one tensioning rod extending through the valve body; and
a biasing spring engaged with the tensioning rod;
at least one load sensor associated with the biasing spring for measuring a tension force in the tensioning rod; and
a controller operably coupled to the tensioning assembly and the load sensor, the controller configured to monitor a preload on the biasing spring to maintain a predetermined sealing tension based on real-time feedback from the load sensor.

2. The multiport rotary valve assembly of claim 1, wherein the annular seal or sealing assembly comprises one or more radial seals constructed of one or more elastomeric or thermoplastic materials seated within a seal groove on the sidewall of the housing ring and/or the periphery of the process disc.

3. The multiport rotary valve assembly of claim 2, wherein the radial seals are constructed from fluorocarbon rubber, closed cell neoprene, polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof.

4. The multiport rotary valve assembly of claim 3, wherein the closed cell neoprene comprises standard 60A through 90A or higher durometer.

5. The multiport rotary valve assembly of claim 3, wherein the nitrile rubber comprises carboxylated nitrile rubber (XNBR), hydrogenated nitrile rubber (HNBR), or a combination thereof.

6. The multiport rotary valve assembly of claim 1, wherein the concentric seals or sealing assemblies comprise lip seals constructed of one or more elastomeric or thermoplastic materials and seated within seal grooves on upper and lower sealing surfaces of the process disc, a lower sealing surface of the upper closure disc, and/or an upper sealing surface of the lower closure disc.

7. The multiport rotary valve assembly of claim 6, further comprising one or more shims respectively positioned beneath the lip seals.

8. The multiport rotary valve assembly of claim 6, wherein the lip seals are constructed from fluorocarbon rubber, closed cell neoprene, ethylene propylene diene monomer (EPDM) rubber, polytetrafluoroethylene (PTFE), polytetrafluoroethylene (PTFE) impregnated ethylene propylene diene monomer (EPDM), silicone rubber, tetrafluoroethylene/propylene rubber, nitrile rubber (NBR), polyacrylate elastomers, fluorosilicone, neoprene, thermoplastic polyurethane (TPU), fluoroelastomers (FKM), polytetrafluoroethylene (PTFE) coated fluoroelastomers (FKM), injection molded and vulcanized ethylene propylene diene monomer (EPDM), or a combination thereof.

9. The multiport rotary valve assembly of claim 8, wherein the closed cell neoprene comprises standard 60A through 90A or higher durometer.

10. The multiport rotary valve assembly of claim 8, wherein the nitrile rubber comprises carboxylated nitrile rubber (XNBR), hydrogenated nitrile rubber (HNBR), or a combination thereof.

11. The multiport rotary valve assembly of claim 6, wherein the lip seals comprise radial lip seals, axial lip seals, rotary lip seals, V-ring lip seals, or a combination thereof.

12. The multiport rotary valve assembly of claim 6, wherein the lip seals comprise torus-shaped seals, single-lip seals, double-lip seals, triple-lip seals, or a combination thereof.

13. The multiport rotary valve assembly of claim 12, wherein the lip seals comprise static seals, dynamic seals, spring-loaded seals, non-spring-loaded seals, or a combination thereof.

14. The multiport rotary valve assembly of claim 1, wherein the annular seal or sealing assembly, the concentric seals or seal assemblies, or both comprise a non-sealing element for stiffness selected from a metallic, thermoplastic, or thermosetting polymer element.

15. The multiport rotary valve assembly of claim 1, wherein the biasing spring comprises a spring washer or a coil spring.

16. The multiport rotary valve assembly of claim 15, wherein the spring washer comprises a plurality of Belleville spring washers.

17. The multiport rotary valve assembly of claim 1, wherein the controller is configured to display tension and compression data on a display component mounted to the valve assembly.

18. The multiport rotary valve assembly of claim 1, wherein the controller is configured to monitor the preload on the biasing spring, which is used to selectively adjust the amount of sealing tension and compression applied to or maintained on the valve body in response to real-time feedback obtained from the load sensor during startup, operation, and/or cooldown of the valve assembly.

19. A process for maintaining sealing compression of a multiport rotary valve assembly during thermal cycling, comprising:
mounting a mechanically biased tensioning assembly on a valve body, the tensioning assembly comprising a tensioning rod extending axially through the valve body and a tension spring engaged with the tensioning rod and the valve body;
preloading the tensioning assembly to a predetermined preload at ambient temperature;
heating the valve body to a sealing temperature;
measuring, using at least one load sensor, a sealing compression force exerted by the tensioning assembly at the sealing temperature;
comparing the measured sealing compression force to a predetermined target sealing force; and
adjusting a position of at least one fastener along the tensioning rod in response to the comparing to maintain the measured sealing compression force within the predetermined target sealing force.

20. The process of claim 19, further comprising calculating a spring rate, compression length, or both that is necessary for the tension spring to create the predetermined target sealing force.

21. The process of claim 19, further comprising monitoring tension and compression data and providing real-time sealing tension and compression feedback from the tensioning assembly.

22. The process of claim 21, further comprising selectively adjusting an amount of sealing tension and compression applied to or maintained on the valve body in response to the real-time feedback obtained from the instrumentation of the tensioning assembly during startup, operation, and/or cooldown of the valve assembly.
